(19) United States
(12) Patent Application Publication
(10) Pub. No.: US 2011/0098095 A1
(43) Pub. Date: Apr. 28, 2011

(54) DIGITAL RANDOM OUTCOME INTERACTIVE DISPLAY

(75) Inventors: MICHAEL KUHN, SPOKANE, WA (US); DAVID KRISE, SPOKANE, WA (US); TYLER KUHN, SPOKANE, WA (US)

(73) Assignee: DIGIDEAL CORPORATION, SPOKANE VALLEY, WA (US)

(21) Appl. No.: 12/984,588

(22) Filed: Jan. 4, 2011

Related U.S. Application Data
(63) Continuation-in-part of application No. 12/353,262, filed on Jan. 14, 2009.
(60) Provisional application No. 61/292,158, filed on Jan. 4, 2010.
(60) Provisional application No. 61/115,544, filed on Nov. 18, 2008.

(51) Int. Cl. A63F 9/24; G06F 3/041

(52) U.S. Cl. 463/16; 345/173

(57) ABSTRACT

A digital random outcome interactive display (“droid”) is provided. In one implementation, an example droid consists of a visual display accessory for a gaming environment, such as for conventional and electronic game tables in a casino. The droid can provide a random outcome for each round of a game being played. The random outcome may be displayed as virtual dice, coins, tiles, dominos, playing cards, numbered balls, spinner, roulette wheel, or combinations of such virtual game pieces. Droid devices may optionally be networked with each other to manage a progressive jackpot across multiple games and players, communicate identity of a winning player to multiple locations, broadcast an image, message, camera feed, video, sound, or television feed to multiple game locations, or administer side betting rounds and bonus rounds across multiple game locations. Droids networked with each other and a server may also provide interactive menus for services, food and drink, shopping, and Internet.

### RELATED APPLICATIONS

This patent application claims priority to U.S. Provisional Patent Application No. 61/292,158 to Kuhn et al., filed Jan. 4, 2010, entitled, “Digital Random Outcome Interactive Display,” which is incorporated herein by reference in its entirety; and also claims priority as a continuation-in-part application to U.S. patent application Ser. No. 12/353,262 to Kuhn, filed Jan. 14, 2009, entitled, “Interactive and Programmable Media Sign and Graphical User Interface for Casino Games,” which is incorporated herein by reference in its entirety, which in turn claims priority to U.S. Provisional Patent Application No. 61/115,544 to Krise et al., entitled, “Interactive and programmable media sign and graphical user interface for casino games,” filed Nov. 18, 2008, and incorporated herein by reference in its entirety.

### BACKGROUND

Many games depend on random numbers or on random events that add surprise, luck, and chance to games, such as throwing dice, spinning wheels, or drawing random cards. Traditional game pieces for generating the random outcome suffer from drawbacks of limited visibility and volatility. The limited visibility arises because traditional game pieces are often small: coins, cards, dice, and so forth, so that a larger audience may have difficulty seeing the actual random result. Volatility arises because a dealer or player may move the game pieces that generate the random result before all players or bystanders can register the results. The effort needed to see the random outcome and to follow the game with enough attention to avoid missing a result can add some strain to playing the game.

At a crowded craps table, for example, players and bystanders may not be able to see the thrown dice or may see them too late after they are handled again. For wagering games, the limitations imposed by particular local jurisdictions may add to the disadvantages of conventional random outcome generating pieces. For example, in a jurisdiction that allows bingo balls randomly selected by a mechanical blower, the balls are not easy to see at a distance and they often move before many players can see or check the results.

What is needed is a random outcome generating device that is comfortably visible and pleasantly interactive and controllable to persist the results long enough for all to see. Such a device may be recruited to provide many other display benefits in addition to generating random outcomes for rounds of a game. In addition, such a device may replace playing cards, mechanical shufflers, and reduce employee labor.

### SUMMARY

In one implementation, a digital random outcome interactive display (“droid”) consists of a visual display accessory for a gaming environment. The gaming environment may be, for example, a conventional or electronic game table in a casino. The droid can provide a random outcome for each round of a game being played. The random outcome may be displayed as virtual dice, coins, tiles, dominos, playing cards, numbered balls, a spinner, roulette wheel, or combinations of these and other such virtual game pieces. An example droid can directly generate the random outcome when actuated, or can convert a random outcome from real game pieces, such as dice, to a different random outcome in another form.

Droid devices may optionally be networked with each other to manage a progressive jackpot across multiple games and players, communicate identity of a winning player to multiple locations, broadcast an image, message, camera feed, video, sound, or television feed to multiple game locations, or administer side betting rounds and bonus rounds across multiple game locations. Droids networked with each other and a server may also provide interactive menus for services, food and drink, shopping, and Internet.

This summary section is not intended to give a full description of digital random outcome interactive displays, or to provide a comprehensive list of features and elements. A detailed description with example implementations follows.

### BRIEF DESCRIPTION OF THE DRAWINGS

FIG. 1 is a diagram of example digital random outcome interactive devices (“droids”) in a gaming environment.

FIG. 2 is a block diagram of an example droid.

FIG. 3 is a block diagram of an example droid network.

FIG. 4 is a block diagram of a master-slave droid network.

FIG. 5 is a diagram of an example random outcome program on an example droid for the game, California Card Craps.

FIG. 6 is a diagram of example color assignment to dice associated with playing card decks.

FIG. 7 is a diagram of an example random outcome program on an example droid for the game, Crapoulette.

FIG. 8 is a diagram of an example random outcome program on an example droid for the game, Bingo Roulette.

### DETAILED DESCRIPTION

Overview

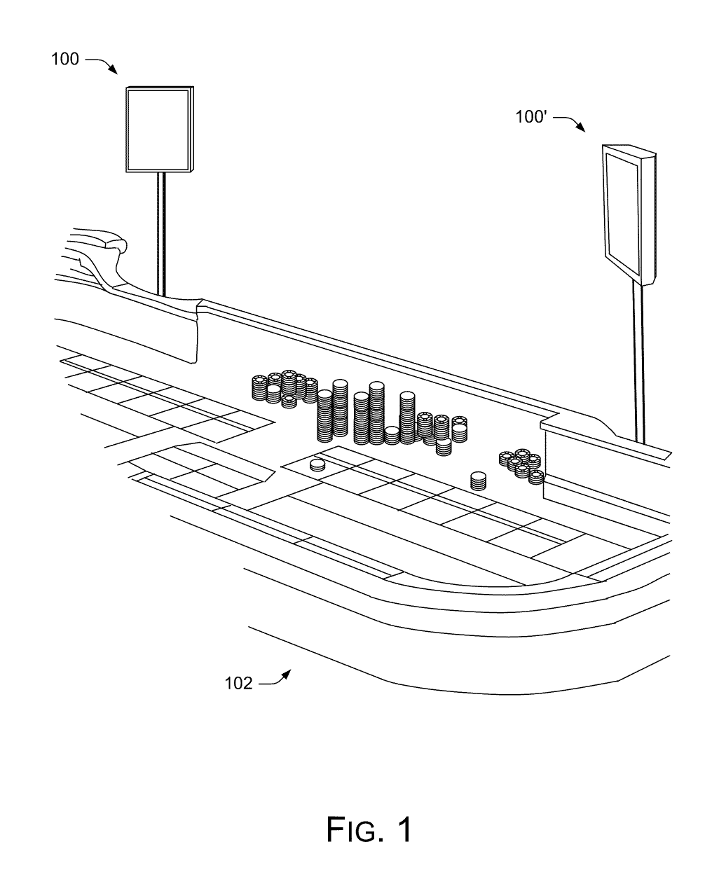

As shown in FIG. 1, this disclosure describes a digital random outcome interactive display (“droid”) 100. In one respect, the droid 100 is a type of signage system for multiplayer gaming, such as casino wagering. An example droid 100 provides an interactive and programmable media sign and associated graphical user interfaces (GUIs) for displaying and editing casino information and/or game information. However, the droid 100 also generates a random event needed to play each round of a wagering game, such as rolling dice or producing a random playing card value. In a typical application, a single droid 100 or multiple droids (e.g., 100 and 100′) generate random outcomes for a game, e.g., around a game table 102, and also provide programmable media signage for the game and for the casino.

Each droid 100 may be attached to a surface (e.g., floor, table, wall) with a mounting device to fix an enclosure of the droid 100 above a horizontal surface used for playing a game. In one implementation, a droid 100 is embedded horizontally in a countertop or game top. A typical mount holds the visual display surface of the droid 100 in a vertical disposition, which may be adjustable for tilting in all directions or rotating about the mount.

In one implementation, a droid system is comprised of a number (e.g., two) of individual droids (e.g., 100 and 100′) communicatively coupled together and running innovative software together. The droid hardware can be mounted to any existing table 102, such as a Craps table. An important purpose of the droids 100 is to electronically select and display a chance or random outcome for each round of the game at hand, e.g., a dice roll, a roulette wheel spin, a sum of playing cards, and so forth.

Example Droid Configuration

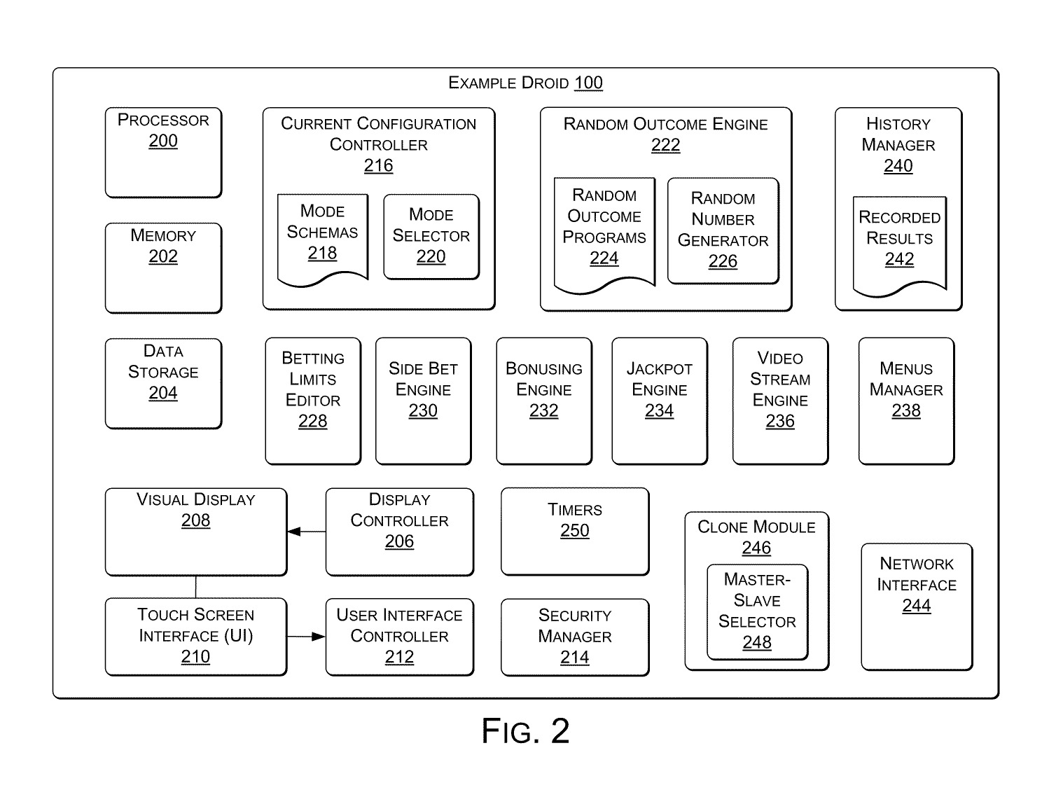

In one implementation, an example droid 100 consists of a self-contained computing device unit with touch screen display and other components. FIG. 2 shows an example droid 100 in greater schematic detail than in FIG. 1. The illustrated implementation is only one example configuration for the sake of description, to introduce features and components of the droid 100. Many other arrangements of the components and/or functions of a droid 100 are possible within the scope of the subject matter. The droid 100 is implemented in hardware, or in combinations of hardware and software. Illustrated components are communicatively coupled with each other for communication as needed.

The example droid 100 includes computing-device components, such as a processor 200, memory 202, and data storage 204. A display controller 206 controls a visual display 208, which may also include a touch screen interface (user interface) 210, coupled with a user interface controller 212. Input received via the touch screen interface 210 may be processed by a security manager 214 (e.g., to apply logon or password functions) to prevent unauthorized change of droid settings.

The droid 100 may operate in multiple different modes, or may perform multiple functions simultaneously. A current configuration controller 216 includes stored mode schemas 218 and a mode selector 220 so that a user can select through the touch screen interface 210 how the droid 100 functions. Functions of the droid 100 may also be selected remotely when the droid 100 is connected to a network.

A random outcome engine 222 generates the random outcome events, and includes one or more random outcome programs 224 and a random number generator 226. Each random outcome program 224 includes programming, i.e., software, that controls the operation and graphics of the droid 100. For example, a first random outcome program 224 may display the random outcome with dice graphics, while a second random outcome program may generate a random outcome though multiple user interactions at the touch screen interface 210, displayed as dominos graphics. They random number generator 226 is typically a jurisdictionally approved routine or engine that is certified to generate a truly random numerical output.

Besides generating and displaying a random outcome though a random outcome program 224, the droid 100 may perform and offer many other functions within its selectable mode schemas 218. In one implementation, the droid 100 displays betting limits, as editable through the touch screen interface 210 or other user interface, on the visual display 208. A side bet engine 230 may offer secondary game options as an auxiliary to the main game being played. The droid 100 may also include a bonusing engine 232, to award an enhanced prize as an auxiliary to the main game being played, for which the droid 100 is generating random outcomes.

A jackpot engine 234 may administer a progressive jackpot between multiple instances of the droid 100, connected together for communication. A video stream engine 236 can enable one or more of the droids 100 to serve as video monitors to one of more game locations within a casino. A menus manager 238 may enable each droid 100 to offer various interactive menus, so that a user may order food and drink, casino services, or even shop or access the Internet.

A history manager 240 has access to a record of past recorded results 242, which may include the past random outcomes generated by the droid 100. In one implementation, droids 100 are communicatively isolated from the primary game activity for which the droid 100 generates random outcomes, except such communication as is signaled by a human user touching the touch screen interface 210. In another implementation, a droid 100 is communicatively coupled with the primary game activity that the droid 100 is generating random outcomes for, i.e., when electronic games are in play, and when communication between the electronic game and the droid 100 is desirable. In this case, the primary game activity may signal the droid 100 to generate a random outcome, or to perform another function, such as a side bet or a bonusing round when triggered by a circumstance of the primary game activity for which the droid 100 generates random outcomes. In this use of the droid 100, the history manager 240 may also display past results of the primary game, which may also be included in the recorded results 242.

A network interface 244 enables the droid 100 to connect with other droids 100 into a network. In one implementation, this network is a closed network of droids 100 only. In another implementation, only two droids 100, or limited number of droids, can connect with each other to provide redundant display of random results and graphics at a single game location or a single game table. In this case, the clone module 246 sets up the limited network through the network interface 244 and a master-slave selector 248 controls which droid 100 is master and which droid(s) 100 are passive redundant displays. One or more timers 250 may automate the generation of random outcome sequences. In one implementation, after a random outcome is displayed and an operator has resolved all wagers in a casino game, a simple touch of the touch screen interface 210 begins a new animated random outcome sequence.

The network interface 244 may also allow each droid 100 to connect to a standard network, e.g., an Ethernet, and/or the Internet, to provide advanced modes 218 and functions, such as progressive jackpots though the jackpot engine 234, broadcast of video to multiple droids 100 via the video stream engine 236, display of menus for ordering goods and services across multiple droids 100, and so forth.

Example Network Configurations

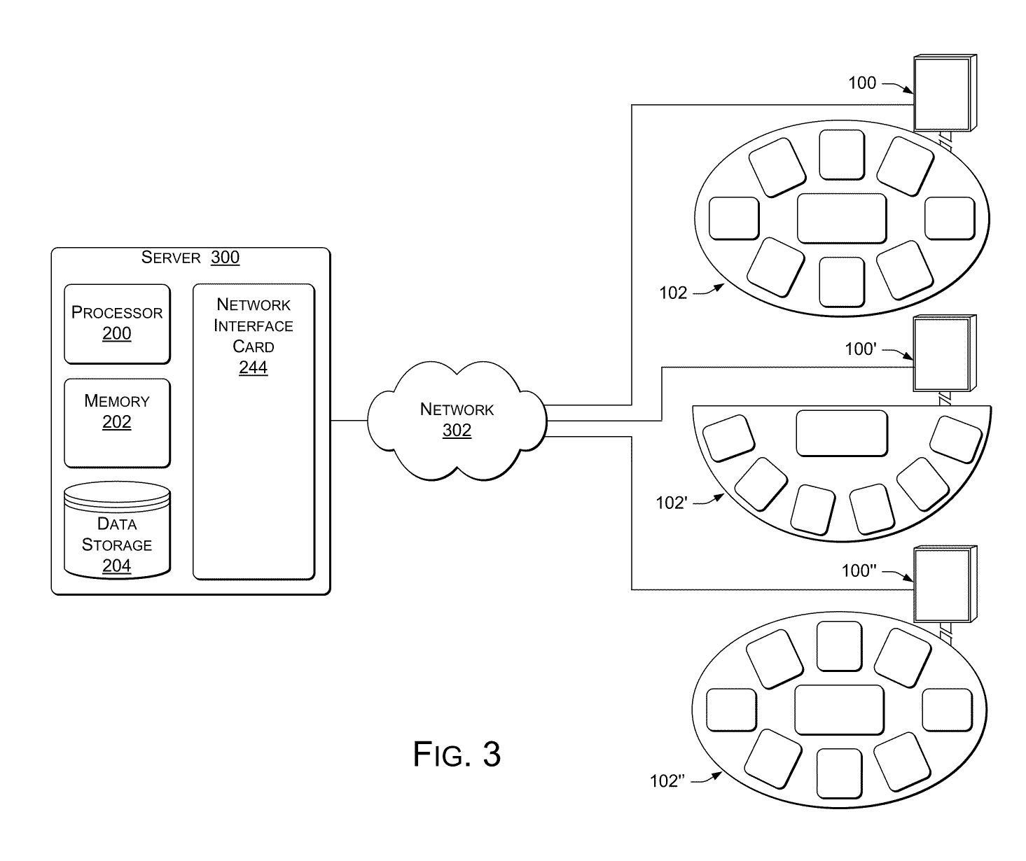

As just described, and as shown in FIG. 3, a network interface 244, e.g., a network interface card (NIC), may be implemented in versions of the droid 100 that communicatively connect with each other; or with an electronic game, the Internet, a remote server 300, etc. FIG. 3 shows an example system in which multiple droids (100, 100′, 100″) are communicatively coupled with each other and with a server 300 via a network 302, but are isolated from the electronics of the game environments that they serve (electronic game tables 102, 102′, and 102″).

The example system in FIG. 3 includes the server computing device 300, which can be a computer or other device that has processor 200, memory 202, data storage 204, and a network interface 244. In one implementation, the network 302 allows the server 300 to simultaneously access the current configuration controller 216 on every droid 100 connected to the network 302, so that an operator can simultaneously configure every droid 100 in the casino at once. This may include selecting a given mode schema 218, functionalities, and options, for every droid 100. The mode schemata 218 may include a random outcome generating mode, an announcement mode, a video mode, a menuing mode, a side bet mode, a bonus round mode, an intercom mode, a progressive jackpot mode, etc. In one implementation, multiple modes may be simultaneously operative in a given instance of a droid 100. Each mode may be allotted an area or a pane on the entire visual display 208 of a given droid 100.

Thus, the example droid 100, which typically includes its own computing device components, is networked with the server 300 and with other droids 100′ & 100″ to provide local random outcome results, side bets, and bonus rounds for its associated game table or game environment, and to optionally display a wide range of information from the server 300, such as progressive jackpots, advertisements, news, pay-per-view events, announcements, ordering menus, intercoms, schedules, custom images, animation, video; commercial broadcasts, Internet access, etc. The server 300 may also be another third party casino system to display other pertinent or casino-related data or information.

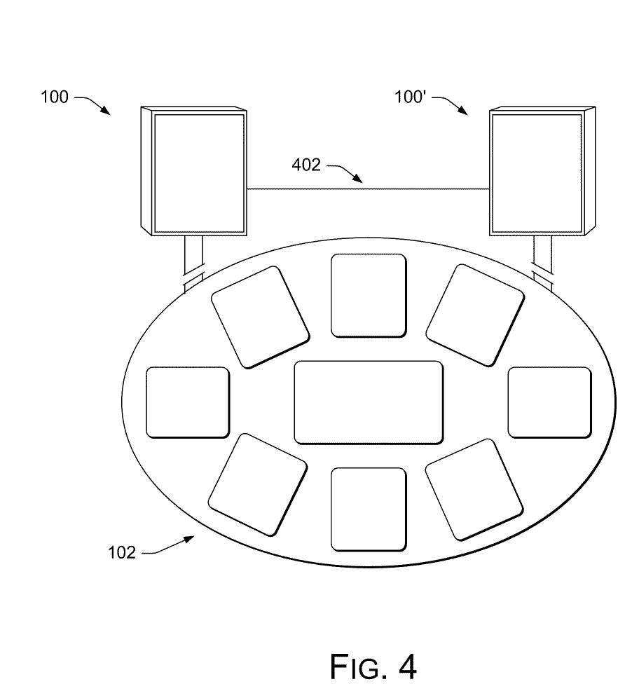

FIG. 4 shows another network configuration between two droids 100 & 100′, or between a limited number of droids 100 placed in the same gaming environment, that is, placed to serve the same game. In this configuration, the two droids 100 are communicatively coupled with each other, but are not coupled with any server 300 or with any electronics of the game 102 for which they generate random outcomes. In this scenario. The droids 100 may be connected via a simple network 402 (made visible in FIG. 4 merely for the sake of illustration) so that one droid 100′ passively displays what the other droid 100 is generating and displaying, as managed by the clone module 246 and the master-slave selector 248. For example, a simple CAT5 Ethernet connection (e.g., twisted wire pairs) may be sufficient to link one or more passive droid displays to a master droid 100 generating random outcomes.

The master-slave selector 248 can enable an operator to select which units in a network of droids 100 can allow user input, and which are solely passive displays. In one implementation, a droid network can be managed from one “master unit” of from a select subgroup of “master units” without connecting to a non-droid computing device or server 300.

Supervisor privileges may or may not be allotted to each networked droid 100 via keyed access. The keyed access may consist of either a physical key, hardware, or a software key (e.g., a PIN or secret).

In another implementation, when intentionally networked with an electronic wagering game, the droid 100 typically becomes a passive recipient of game information for purposes of display only so that the security of the electronic game is not compromised.

Example Functions

In preferred embodiments, programming of displayable content is carried out through the self-contained touch screen interface 210 (or via a server 300, when networked). Images and video content for display can be uploaded through a port or downloaded via the network interface 244. In one implementation, the droid 100 may store a profile or configuration file of its displayable content and settings that can be transferred to other instances of the droid 100.

At a basic level of implementation, in which the droid 100 functions as a self-contained sign for an individual casino table 102 or game, the droid 100 can display an animated game logo, e.g., a custom logo or animation, and betting limits for a casino table game. Even as a standalone game table display, the droid 100 can also act as a promotion display and advertising device for the gaming establishment. The droid 100 includes the touch screen interface 210 which may enable the gaming establishment to access a system of GUIs that have logically related pages to enable an operator to program the visuals displayed by the droid 100 without having to resort to extra user interface devices, such as keyboard and mouse, to program the display. In other words, the droid 100 displays information and animated graphics and is fully programmable “on its face,” that is, via a user operating the front-facing touch screen interface 210 without requiring other equipment.

In one implementation, the droid 100 identifies a specific touch gesture on the face of the touch screen interface 210 to reveal and enable access to a security GUI for entering a secret, such as a key, code, or password authenticated by the security manager 214. The secret maintains security over the hierarchy of GUI pages and other functionality that enable editing or selecting displayable content. Typically, a user must be authenticated by the security manager 214 to select or change the programming. The gesture for revealing the security GUI need not itself be secure, and may consist of various finger motions, e.g., a sequence of finger motions along one or more sides of the touch screen interface 210 (for a single-touch implementation of the droid 100), or a combination of finger contacts and movements (for a multi-touch implementation of the droid 100). Once access is gained, the gaming establishment can access the betting limits editor 228 to change game limits and edit message areas to be presented on the display, or import custom graphics, e.g., for a promotional slide show.

In one implementation, the droid 100 is interactive in real time with an electronic game, albeit passively. That is, droid 100 can display game states and other information as the game is played in real time. For example, the media sign can display numbers drawn, cards dealt, card hands, dice rolled, bets wagered, winners and losers, stages of the game, jackpots, etc. In one implementation, the jackpot engine 234 of the droid 100 displays a progressive jackpot meter between multiple droids 100 at multiple game devices.

In one implementation, a game/movie pane or area of the visual display 208 of the droid 100 presents a custom graphic, logo, video, or animation. For example, a video may be stored and played on continuous loop, or the video may be streamed from an external source. In one implementation, the droid 100 displays one or more television channels on at least a part of the visual display 208. Thus, game players may watch television and/or videos while playing the casino game, or between rounds.

Example Random Outcome Programs

An example droid 100 may store or be programmed with multiple random outcome programs 224. Each random outcome program 224 can be executed by the processor 200 to implement a random outcome sequence for each round of a game. An example random outcome sequence consists of an animated representation of a shuffle, for example, and random distribution of virtual (digital) cards, or other game pieces, e.g., face down, or visually spinning until selected.

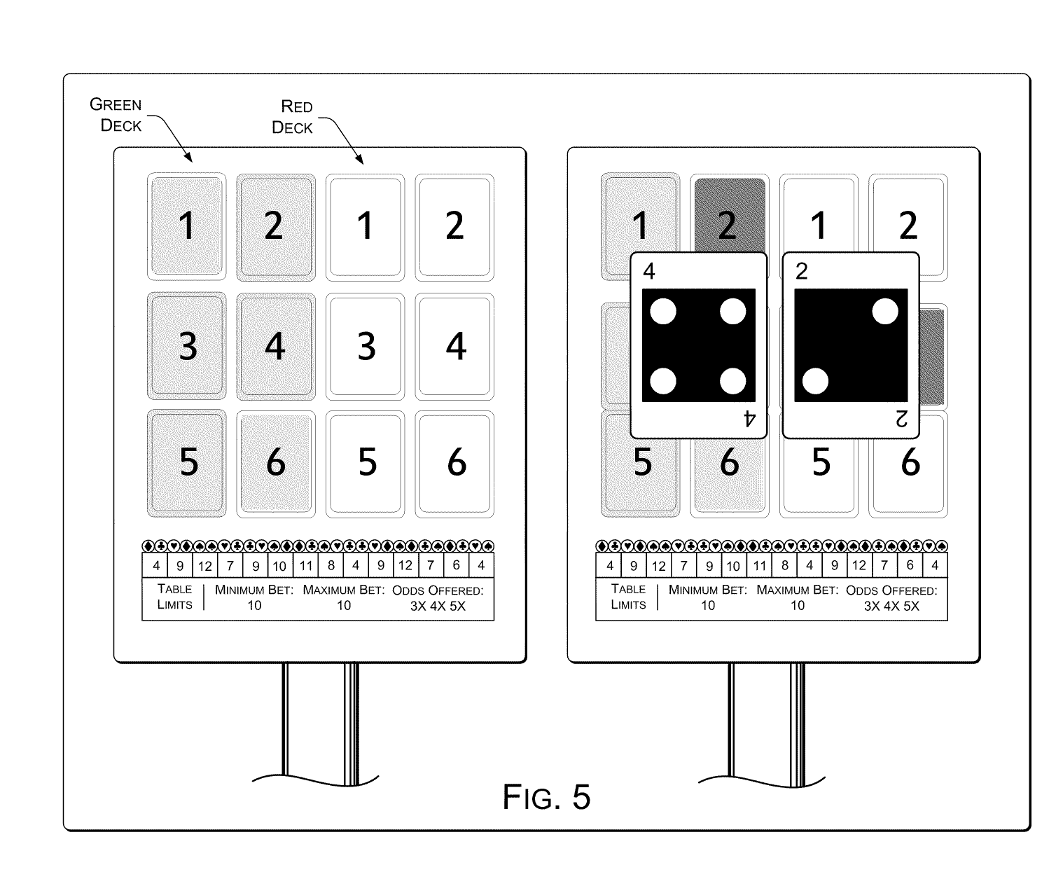

FIG. 5 shows visual output on the visual display 208 generated by one example random outcome program 224 suitable for California Card Craps. Two 6-card virtual decks (e.g., one visually green and one visually red) each consisting of an Ace (1) through Six (6) and showing a corresponding dice pattern, are randomly shuffled and selected resulting in a numerical outcome total of between 2 and 12 for a round of a game. In this random outcome program 224, each droid 100 can also display various outputs, such as the table limits and odds, a history of the last “X” rolls or shuffles (e.g., fifteen rolls), and a current state of the game (e.g., in Craps, the “come out roll”). The droid 100 thus programmed may allow two (or more) separate options for determining the outcome total in order to match current methods of play, for example, as played in California.

For example, a one-step option (not shown) simply shows the two virtual decks (green and red in FIG. 5) spinning vertically with a “show outcome” button on the touch screen that the table operator may touch to initiate the random selection and outcome.

An example two-step option allows the shooter/player to roll two real dice (e.g., one green and one red) to determine which red and green cards are selected and exposed by the table operator to get an outcome total. In one version, a table operator executes the selection and initiation of an outcome, while in another version a selected player initiates the outcome total through a button at or near the player.

As introduced above, the initiation of the random outcome sequence can be controlled by the game operator, by a player, or can be fully automatic through the use of timers 250 (e.g., by selecting that option in a setup menu). For example, after a random outcome is displayed and the operator resolves all wagers, the operator may merely touch the touch screen interface 210 to begin a new animated random outcome sequence. The sequence may consist of an animated representation of a shuffle and the random distribution of the selected game pieces (dice, cards dominos, etc.) face down or otherwise hidden.

At least two types of play out modes, “automatic” and “player assisted” can be made available by a droid 100. If an automatic play out mode has been selected, then one of the randomly distributed game pieces is automatically selected and displayed as the final outcome. If the “player assisted” mode is selected, then the randomly distributed game pieces remain face down, visually spinning, or otherwise obscured, awaiting selection by the operator based on the player-supplied input information. The player-supplied input can be obtained from actual, real game pieces. The outcome of a real game piece, e.g., dice, can be used either for selecting a randomized virtual playing piece shown on the visual display 208 (e.g., designating a position or coordinates on the visual display 208), or by seeding the random number generator 226 of the droid 100 with the outcome from the real game piece(s). The random number generator 226 may be thus seeded, in “player assisted” mode, by outcome from real coins, cards, dice, dominos, numbered balls, spinners, roulette wheels, and so forth. A player or operator might roll dice, for example, to determine which pieces to reveal, or might simply telling the operator when to stop the visual spinning action of a virtual game piece shown on the visual display 208, or might directly indicate which piece with concealed identity to select. The player assist mode allows the player to be more involved with the game outcome process.

In the example random outcome sequence implemented by the random outcome program 224 suitable for California Card Craps, two top cards of two visual card stacks or decks may be selected and revealed. The outcome total is then displayed on the visual display 208 and history bar is updated by the history manager 240.

The revealed cards are then turned face down after a predetermined amount of time measured by a timer 250 or when the table operator touches the touch screen interface 210 e.g., in a location above the displayed table limits.

The two decks (e.g., one red and one green) may be cut and animated into two stacks of 12 each and then shuffled back into two 24-card decks. The shuffle animation may be repeated for a set amount of time or until the operator touches the screen above the table limits.

The table operator may touch the touch screen interface 210 to reveal both top cards or can touch each card individually to reveal one card at a time. The two revealed cards are displayed along with an outcome total message. When the table is closed an idle screen may displays the game logo.

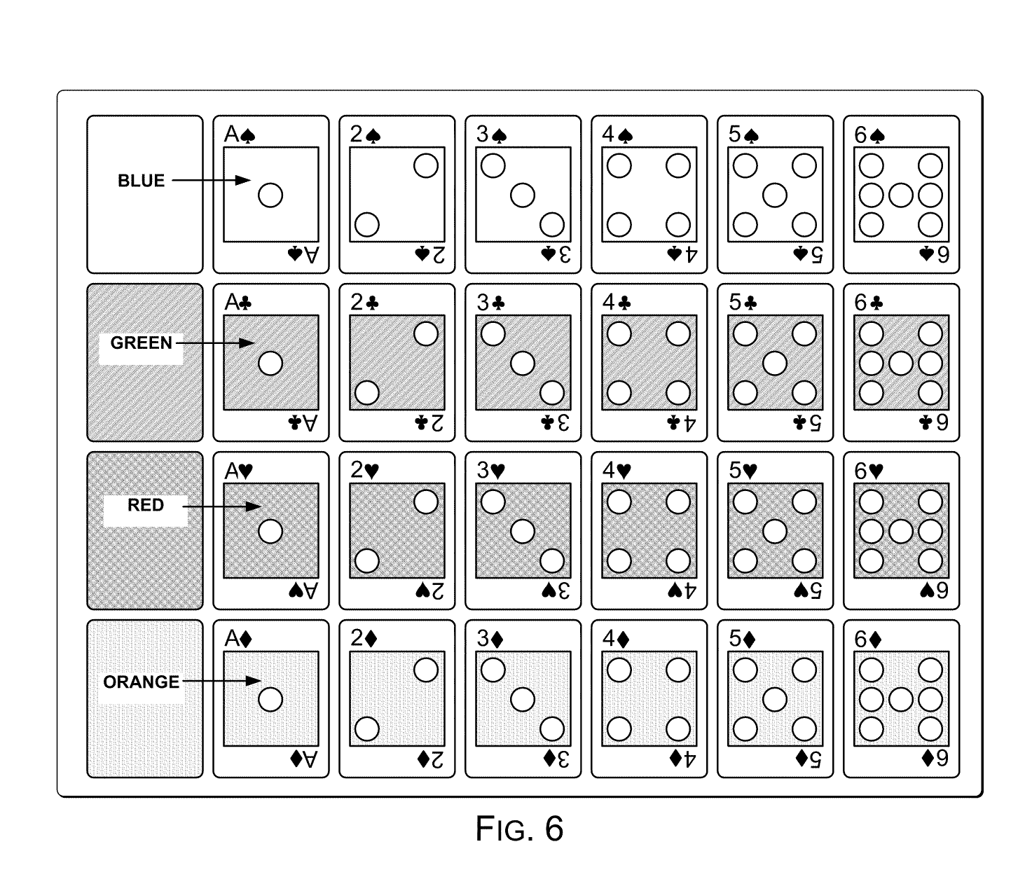

In this implementation, as shown in FIG. 6, each deck of the virtual cards may consist of 24 cards, and four suits, with Ace (1) through Six (6). Each suit may have a different color dice symbol representing the card value. Thus, in one implementation the heart suit is assigned red, the diamond suit is assigned orange, the club suit is assigned green, and the spade suit is assigned blue.

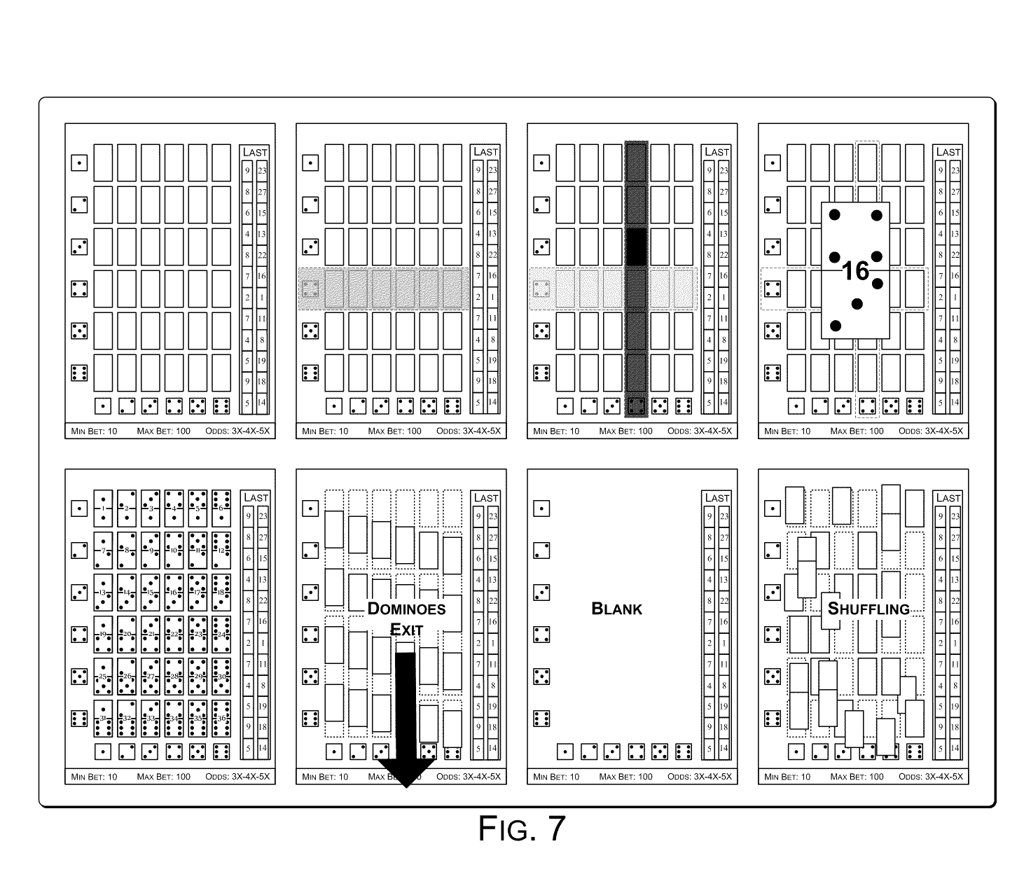

FIG. 7 shows a Crap/Roulette “Crapoulette” implementation of an example random outcome program 224 that uses dice and domino images. The illustrated implementation depicts a player assist mode and is only one example to show the interactive and random outcome features of a droid 100.

In FIG. 7, thirty-six (36) dominoes have been randomly distributed face-down awaiting selection. A history of the last 25 games or rounds may also be visually displayed. In this implementation, the player rolls two dice: e.g., one red die and one green die. The operator selects and touches the first corresponding die button represented on the visual display 208, selecting the associated row, which is highlighted.

The operator then selects and touches the second corresponding die button on the visual display 208, selecting the associated column, which is highlighted and the domino at the intersection of the row and the column is selected, and enlarges. If the selection is correct, then the operator touches the representation of the large domino “16” and the selected virtual domino animates and enlarges to show the final outcome. In the game, the dominoes may represent both a dice outcome (dots), a number, and a color (red and black) roulette outcome.

The operator may then start a new random outcome sequence by touching the touch screen interface 210. The large domino from the previous action reduces in size, and all dominoes are shown. Then, the dominoes turn face down and animate off the screen. The displayed history outcome is updated. The visual display 208 shows 36 empty spaces as the dominoes begin to randomly re-populate the blank spaces until all 36 dominoes have been randomly distributed face down awaiting a new selection process.

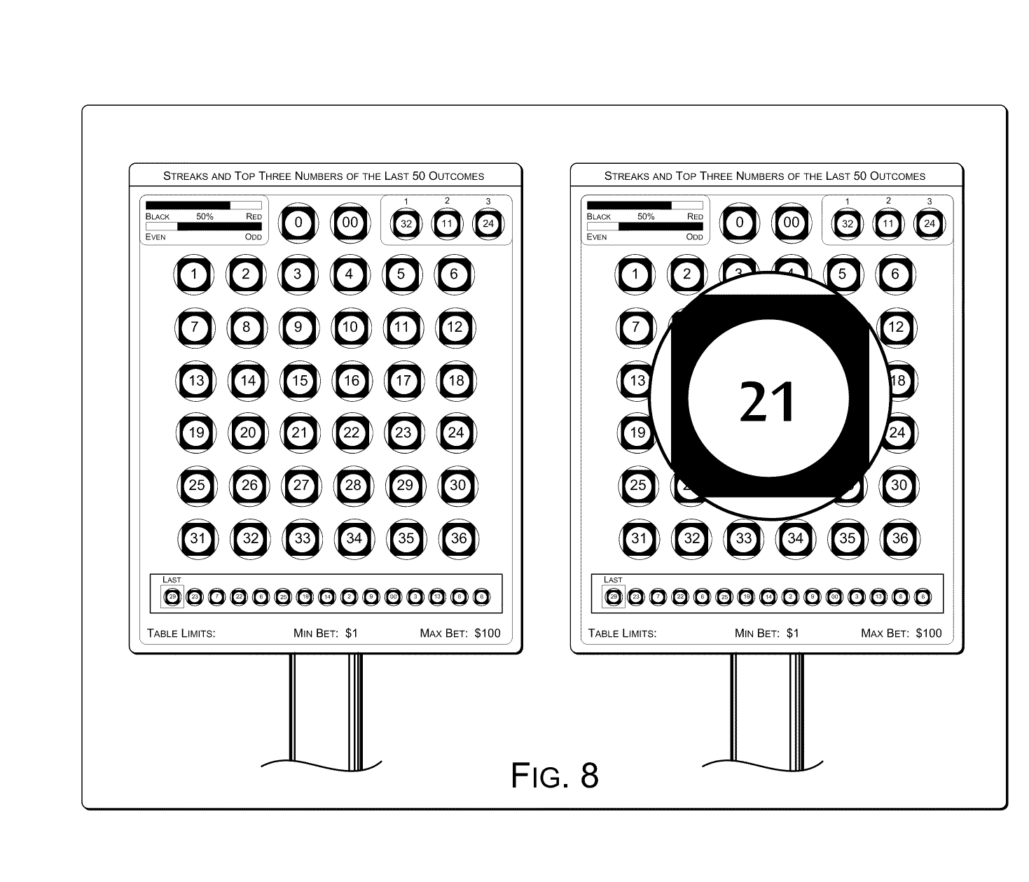

FIG. 8 shows another example random outcome program 224, in this case for Bingo Roulette. In this implementation, the example droid 100 displays, e.g., 38 bingo balls. The droid 100 may also display a history or games or rounds. The random outcome program 224 can display red & black, and even & odd streaks. The example random outcome program 224 may display the top three numbers of the most recent fifty. The example droid 100 may implement manual or an auto select versions of the example random outcome program 224.

Conclusion

Although exemplary systems and techniques have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A digital random outcome interactive display, comprising:
a visual display;
a display surface of the visual display configured for interactively receiving touch input; and
a processor for receiving the touch input as digital information, for generating at least a random outcome in response to the digital information, and for displaying a visualization of the random outcome on the visual display.

2. The digital random outcome interactive display of claim 1, wherein the processor executes a random number generator routine to produce the random outcome; and
wherein the random outcome is one of a random number, a random shape, a random symbol, or a random color.

3. The digital random outcome interactive display of claim 1, further comprising a mounting device to fix the visual display above a horizontal surface used for playing a game.

4. The digital random outcome interactive display of claim 1, wherein components of the digital random outcome interactive display are communicatively isolated from a primary game activity for which the digital random outcome interactive display is generating a random outcome.

5. The digital random outcome interactive display of claim 4, further comprising a bonusing engine, which when signaled by the digital information from the touch input, performs a secondary game activity distinguishable from the primary game activity.

6. The digital random outcome interactive display of claim 5, wherein the secondary game activity comprises one of a side bet game round or a bonus prize game round that awards an enhanced prize over the primary game activity.

7. The digital random outcome interactive display of claim 5, further comprising a network connection for communicating with one or more additional digital random outcome interactive displays;
wherein a network of digital random outcome interactive displays performs at least one of the following:
redundantly displays random outcome results and graphics at two or more digital random outcome interactive displays at a single table or game location;
manages a progressive jackpot across multiple games being played in one or more locations;
communicates an identity of a winner at one game location to multiple game locations;
broadcasts an image, message, live camera feed, video, sound, closed-circuit television feed, or commercial television feed to multiple game locations;
administers a side betting game across multiple game locations;
administers a bonus round across multiple game locations.

8. The digital random outcome interactive display of claim 1, further comprising:
a network connection for communicating with one or more additional digital random outcome interactive displays and for communicating with a remote server;
wherein a network of digital random outcome interactive displays performs at least one of the following:
presents an interactive menu of casino or hotel services to at least one game location in a casino for ordering a casino or hotel service;
presents an interactive menu of drinks to at least one game location for ordering a drink;
presents an interactive menu of foods to at least one game location for ordering a food;
presents an interactive shopping menu to at least one game location for online shopping; and
presents an Internet availability to at least one game location for providing an Internet service or a website.

9. The digital random outcome interactive display of claim 1, further comprising a communicative connection with a primary game activity for which the digital random outcome interactive display is generating a random outcome;
wherein the primary game activity is generated by an electronic game;
wherein the primary game actuates the digital random outcome interactive display to perform a secondary game activity distinguishable from the primary game activity;
wherein the secondary game activity comprises one of a side betting round or a bonus prize round.

10. The digital random outcome interactive display of claim 9, further comprising a recording module for displaying a record of past random outcomes generated by the digital random outcome interactive display or for displaying a record of past outcomes of the primary game activity.

11. A system, comprising:
a digital random outcome interactive display, including:
a visual display;
a user interface for entering input;
a processor for receiving the input, for generating at least a random outcome in response to the input, and for displaying a visualization of the random outcome on the visual display;
an enclosure for containing the visual display, user interface, and processor into a self-contained unit; and
a mount connected to the enclosure for positioning the visual display in a vertical viewing position and for attaching or placing the digital random outcome interactive display near a primary game activity for which the digital random outcome interactive display generates a random outcome for rounds of the primary game activity.

12. The system of claim 11, further comprising a bonusing engine to execute a secondary game activity distinguishable from the primary game activity based on the input from the user interface.

13. The system of claim 12, wherein the secondary game activity comprises one of a side betting round or a bonus prize awarding round with respect to the primary game activity.

14. The system of claim 11, further comprising multiple digital random outcome interactive displays communicatively coupled in a network;
wherein the network of digital random outcome interactive displays performs at least one of the following:
redundantly displays random outcome results and graphics at two or more digital random outcome interactive displays at a single table or game location;
manages a progressive jackpot across multiple games being played in one or more locations;
communicates an identity of a winner at one game location to multiple game locations;
broadcasts an image, message, live camera feed, video, sound, closed-circuit television feed, or commercial television feed to multiple game locations;
administers a side betting game across multiple game locations; and
administers a bonus round across multiple game locations.

15. The system of claim 14, wherein the network of digital random outcome interactive displays is communicatively coupled with at least one remote computing device and performs at least one of the following:
presents an interactive menu of casino or hotel services to at least one game location in a casino for ordering a casino or hotel service;
presents an interactive menu of drinks to at least one game location for ordering a drink;
presents an interactive menu of foods to at least one game location for ordering a food;
presents an interactive shopping menu to at least one game location for online shopping; and
presents an Internet availability to at least one game location for providing an Internet service or a website.

16. The system of claim 11, further comprising a communication interface for communicatively coupling with a primary game activity for which the digital random outcome interactive display is generating a random outcome;
wherein the primary game activity is generated by an electronic game;
wherein the primary game activity actuates the digital random outcome interactive display to perform a secondary game activity distinguishable from the primary game activity; and
wherein the secondary game activity comprises one of a side betting round or a bonus prize round with respect to the primary game activity.

17. The system of claim 16, further comprising a recording module for tracking a first record of past random outcomes generated by the digital random outcome interactive display or for tracking a second record of past outcomes of the primary game activity; and
wherein the first record and the second record are displayable on the visual display.

18. A system, comprising:
a digital random outcome interactive display, including:
a visual display;
a user interface for entering input;
a processor for receiving the input, for generating at least a random outcome in response to the input, and for displaying a visualization of the random outcome on the visual display;
an enclosure for containing the visual display, user interface, and processor into a self-contained unit; and
a logic module to use a first random outcome of an actual game piece entered via the user interface to generate a second random outcome from the digital random outcome interactive display.

19. The system of claim 18, wherein the logic module uses a rolled dice outcome from actual dice to select virtual cards or virtual dice on the visual display to generate the random outcome for a round of game play.

20. The system of claim 18, wherein the logic module uses a rolled dice outcome from actual dice to select virtual dominoes on the visual display to generate a random outcome for a spinning roulette wheel of a roulette game.

21. The system of claim 20, wherein the roulette game is virtual.

22. The system of claim 18, wherein the logic module enables real-time visual animations of one or more game pieces to be tactilely interacted with by a player or an operator of a game to generate a random outcome for a round of game play.

23. The system of claim 22, wherein an outcome of actual rolled dice determines at least in part how the player or operator interacts with the visual animations.

24. The system of claim 22, wherein the player or operator interacts with a visual movement of the visual animations of the one or more game pieces to generate the random outcome for a round of the game play.

25. The system of claim 18, wherein the actual game piece comprises one of a die, a coin, a tile, a domino, a playing card, a numbered ball, a bingo ball, a spinner, a roulette wheel, or a combination of these actual game pieces.
